(19) United States
(12) Patent Application Publication
(10) Pub. No.: US 2016/0320629 A1
(43) Pub. Date: Nov. 3, 2016

(54) Fluidic Super Resolution Optical Imaging Systems With Microlens Array

(71) Applicant: SuRe Optics, Inc., Cambridge, MA (US)

(72) Inventors: Frederick J. Leonberger, Sarasota, FL (US); Jeffrey Farmer, Chelmsford, MA (US); Zong-Long Liau, Belmont, MA (US)

(73) Assignee: SuRe Optics, Inc., Cambridge, MA (US)

(21) Appl. No.: 15/142,531

(22) Filed: Apr. 29, 2016

Related U.S. Application Data
(60) Provisional application No. 62/155,608, filed on May 1, 2015.

(51) Int. Cl. G02B 27/58; G01N 21/64; H04N 5/225; G02B 21/02; G02B 3/00; G02B 21/36; G01N 21/05; G02B 21/00

(52) U.S. Cl. CPC G02B 27/58; G01N 21/05; G01N 21/6486; G01N 21/6458; G02B 21/0072; G02B 21/02; G02B 3/0006; G02B 21/36; H04N 5/2254; G01N 2021/6478

(57) ABSTRACT

A fluidic super resolution optical imaging system includes a microlens array chip comprising at least one lenslet on a first surface. An objective lens is positioned proximate to the at least one lenslet. A fluid jet is positioned proximate to a second surface of the microlens array that flows at least one of a fluid comprising a material to be imaged or a material that enables imaging of a second material through a focal area of the objective lens and the at least one lenslet.

### CROSS REFERENCE TO RELATED APPLICATION

The present application is a non-provisional application of U.S. Provisional Patent Application No. 62/155,608 entitled “Fluidic Super Resolution Optical Imaging Systems with Microlens Array” filed on May 1, 2015. The entire contents of U.S. Provisional Patent Application No. 62/155,608 are herein incorporated by reference.

### INTRODUCTION

Fluidic optical imaging systems are a light-based, biophysical imaging technology that employs various mechanisms to position materials suspended in fluid (e.g., biological materials and/or markers) in the imaging path of a detection apparatus. Flow cytometry is one type of fluidic optical imaging system that suspends cells in a stream of fluid and passes them by a detection apparatus. One of the main components of flow cytometers, the flow cell, carries, aligns, and forces the materials under study (i.e., cells or sub-cellular elements) to pass one-by-one under the imaging and/or optical analysis system. In this way, a detailed analysis can be performed with very high throughput. More specifically, flow cytometry allows simultaneous multi-parametric analysis of the physical and chemical characteristics at very high rates, which can exceed many thousands of detections per second. Flow cytometry is employed in cell imaging, cell counting, cell sorting, biomarker detection, protein analysis, and protein engineering, among other uses, in the fields of medicine, biology, and biotechnology for basic research, clinical research, health diagnosis, and manufacturing.

Other types of fluidic optical imaging systems include DNA sequencers, RNA sequencers, nucleic acid probing equipment, high content screening/analysis equipment, PCRs, chromosomal analyzers, immunoassay equipment, protein or molecular probing equipment, Fluorescent In Situ Hybridization (FISH), cell and sub-cellular organelle probes & imaging equipment, and other similar systems.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The person skilled in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1A illustrates an end-view of a fluidic super resolution optical imaging system comprising an integrated microlens array chip with microchannels according to the present teaching.

FIG. 1B illustrates a side-view of a fluidic super resolution optical imaging system comprising an integrated microlens array with channels according to the present teaching.

FIG. 2 illustrates a side-view of a fluidic super resolution optical imaging system of the present teaching suitable for analysis of long molecules such as DNA or RNA.

FIG. 3 illustrates an embodiment of a fluidic super resolution optical imaging system comprising an integrated microlens array with channels and a fluid jet system.

FIG. 4 illustrates an embodiment of a fluidic super resolution optical imaging system of the present teaching comprising a dual microlens array chip configuration including an upper and a lower microlens array chip.

FIG. 5 illustrates an embodiment of a fluidic super resolution optical imaging system comprising a biochip with an integrated microlens array chip according to the present teaching.

FIG. 6 illustrates an embodiment of a fluidic super resolution optical imaging system of the present teaching comprising a biochip and microlens array chip integrated into a flow cell.

FIG. 7A illustrates a top-side view embodiment of a fluidic super resolution optical imaging system including a microlens array with a pattern of lenses of the present teaching.

FIG. 7B illustrates a top-side view of another embodiment of a fluidic super resolution optical imaging system including a microlens array with a pattern of lenses of the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

Prior art optical imaging systems have limited optical resolution and employ imaging systems that limit the size of structures that can be resolved. In addition, prior art optical imaging systems are limited in their throughput in part because of their relatively small size of the optical systems used to gather and direct the light for analysis. Furthermore, low signal-to-noise ratios in prior art commercial optical imaging systems can require larger amounts of the expensive reagents and molecular probes, which can cause the systems to miss important attributes of the sample that is being imaged and/or create a very slow imaging process, both of which are undesirable

Integrated microlens array technology that combines techniques of micro-imaging via solid immersion lenses with various micro-fabrication techniques is emerging. See, for example, U.S. Pat. No. 8,325,420, entitled “Annular Solid Immersion Lenses and Methods of Making Them”. These integrated microlens arrays allow for advanced sample handling capabilities with imaging capabilities that go below the resolution diffraction limit of conventional optical imaging systems. Additionally, these systems enable higher throughput of sample imaging. Furthermore, they greatly improve signal-to-noise ratios, leading to less usage of the expensive reagents and molecular probes. This allows the systems to image important attributes of the sample that is being imaged and/or increase imaging speeds, both of which are desirable in commercial equipment. The integrated microlens array technology can also be combined with techniques of fluorescence microscopy to achieve spatial resolution previously not possible with conventional optical imaging.

One aspect of the present teaching relates to integration of microlens arrays into optical biological imaging and analysis systems in order to enable the biological material to be imaged or analyzed at resolutions near or below the diffraction limit. While the present teaching describes primarily biological applications, it will be apparent to those of skill in the art that there are numerous other imaging applications. For example, the apparatus and methods of the present teaching can be used for semiconductor and other micro-fabrication, manufacturing defect detection, chemical processing, imaging of non-organic materials, and security analysis.

In many embodiments of the present teaching, additional mechanical and/or electrical structures are added to the microlens arrays to provide additional utility. In particular, mechanical channels can be constructed to manage flows and samples for testing in a cytometer configuration. Such systems can be realized with little additional cost over and above conventional imaging, and be easily integrated into existing and emerging optical imaging systems.

Prior art flow cytometers analyze and sort particles in a fluid medium on a particle-by-particle basis for optical analysis. Micro-fluidic cytometry allows similar particle-by-particle analysis techniques to be applied to small biological materials such as cells and sub-cellular structures. An important element in a flow cytometer is the flow cell, which manages the position and movement of the material under test. In the flow cell, a fluid stream carries and aligns the cells to the imaging system. The micro-channels described herein provide a mechanism to carry and align cells. The micro-channels according to the present teaching can be fabricated on or within the microlens arrays.

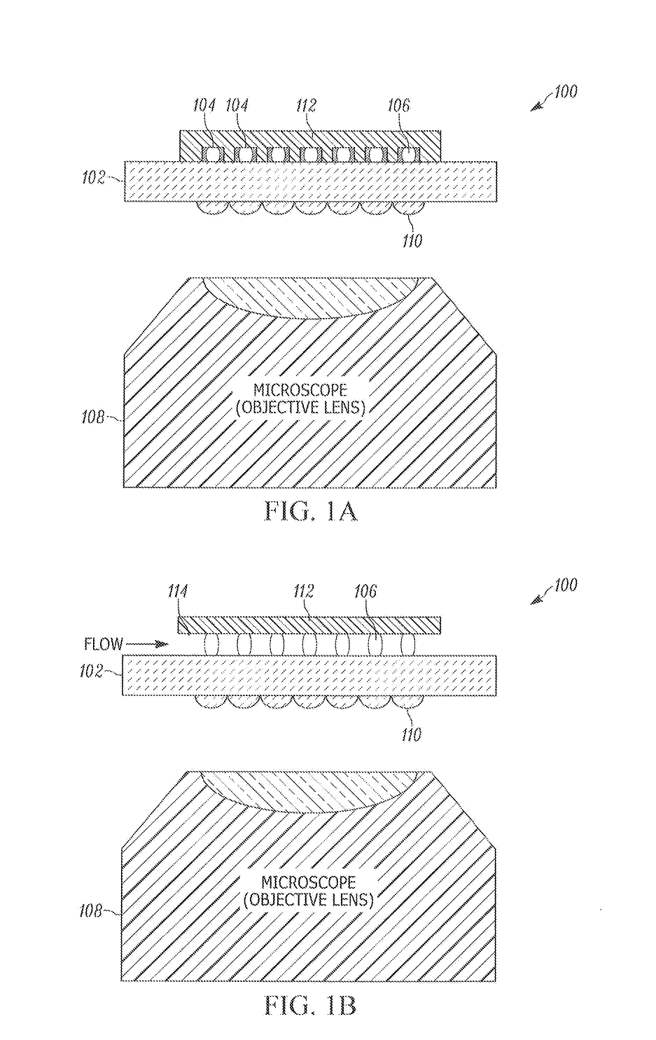

FIG. 1A illustrates an end-view of an imaging system 100 comprising an integrated microlens array chip 102 with microchannels 104 according to the present teaching. The microchannels 104 allow samples 106 to be moved across the microlens array and imaging field of a microscope objective 108. In FIG. 1A, the microchannels 104 are aligned on an axis oriented into the plane of the figure. In some embodiments, the microscope objective 108 shown in FIG. 1A is replaced with other known imaging systems in the art. The microscope objective 108 may be part of a high-resolution imaging system for biological materials. In some embodiments, the microlens array chip 102 includes solid immersion-type lenslets 110. The lenslets 110 allow individual high resolution imaging of the sample material residing directly over the lenslet 110. In some embodiments, the material is positioned in the focal area of the microscope objective 108 and the lenslet 110. In some embodiments a light source (not shown) is used to illuminate the samples.

In various methods of operation, the samples 106 may include any of a variety of biological specimens including cells, or cellular subcomponents such as DNA, RNA molecules, nucleus, mitochondria, and other sub-cellular molecules and organelles. The samples may or may not be tagged with fluorescent particles, quantum dots, nanotubes or other types of probes. In some embodiments, the channels 104 are designed to create a partial flattening of the cells pressed against the bottom side of the microlens by a cover 112. In some embodiments, the cover 112 may comprise a microscope slide or microscope slide cover or other type of flow cell cover.

FIG. 1B illustrates a side-view of an imaging system 100 comprising an integrated microlens array with channels of the present teaching. This view of the imaging system 100 is that of the imaging system 100 shown in FIG. 1A rotated by 90 degrees. In the side-view shown in FIG. 1B, the channels are located along the surface of the microlens array chip 102 and are oriented along an axis running from left to right across the figure. Individual channels are not visible in this orientation of the figure. Individual samples 106, such as cells, flow along the channels and pass over the lenslets 110. The flow is enabled by a medium 114. In some embodiments, the medium 114 includes a liquid or a gas. In some particular embodiments, the medium 114 is a shear liquid. In various embodiments, the flow mechanism includes fluidic pressure, or mechanical or electrical forces. In some embodiments, a fluid jet system is used to propel the biological material across the microlens array. Also, in some embodiments, the transfer mechanism for the sample to be imaged also includes a pick-and-place type mechanism. Also, in some embodiments, samples are dropped by liquid handlers.

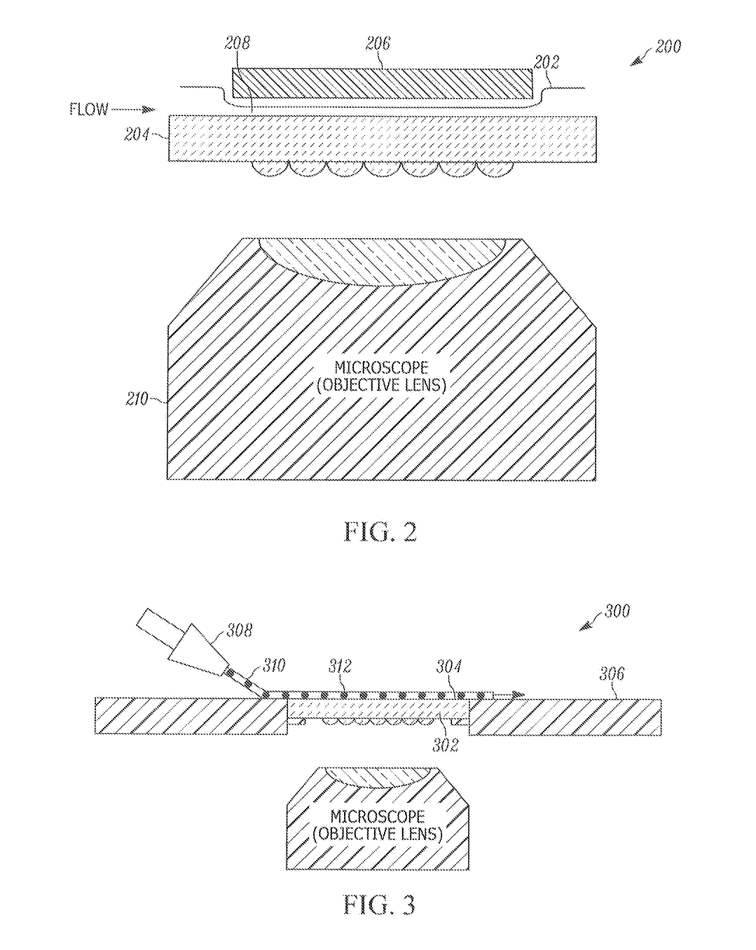

Another feature of the channelized microlens arrays of the present teaching is that it is particularly well suited to image long strands of material, such as DNA, RNA, chromosomes in general, or other similar long-strand material sample. FIG. 2 illustrates a side-view of an imaging system 200 of the present teaching suitable for long-strand material imaging. In the imaging system 200 shown in FIG. 2, channels are located along the surface of the microlens array chip and are oriented along an axis running from left-to-right across the figure. Individual channels are not visible in this orientation.

FIG. 2 illustrates a section of long strand material 202, such as DNA, located in between a microlens array chip 204 and a cover 206. A medium 208 is used to allow the long strand material 202 to move across the microlens array chip 204. In various embodiments, fluidic, mechanical and/or electrical forces are used to propel the long strand material. The long strand material 202 is imaged through the microlens array chip using a microscope objective 210, or other imaging system. In other methods, other biological material, such as a fatty acid chain, or other long strand of biological material are probed by the imaging system 200.

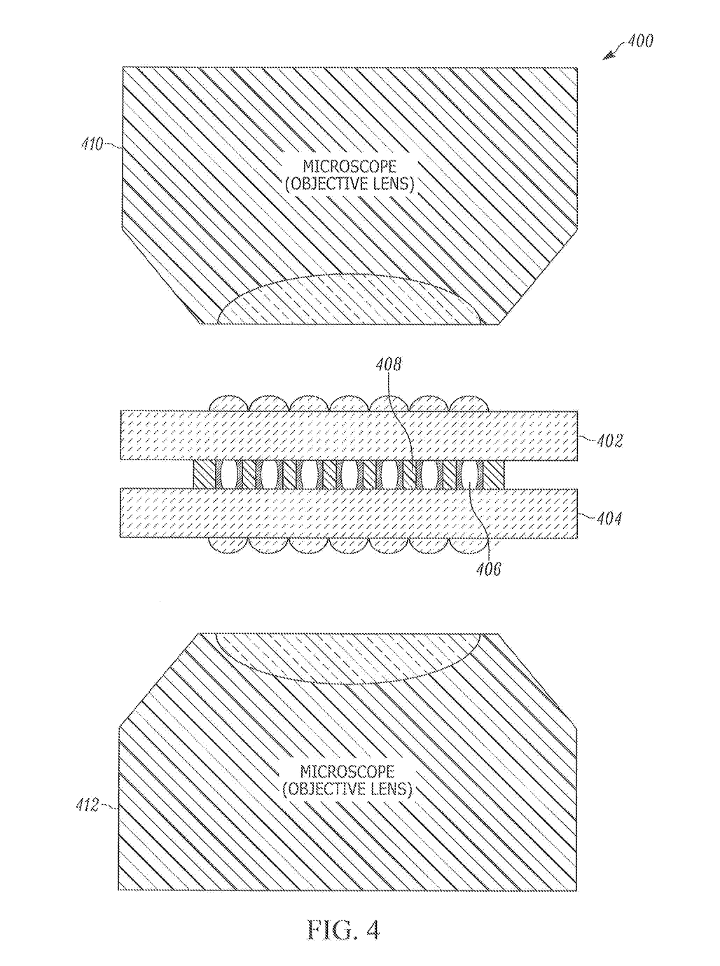

One feature of the methods and apparatus of the present teaching is that biological samples can be rapidly imaged because biological samples can be moved rapidly across the field of view in imaging systems according to the present teaching. FIG. 3 illustrates an embodiment of an optical imaging system 300 comprising an integrated microlens array 302 with channels and a fluid jet system. The channels run across the figure on the top surface 304 of the microlens array chip 302. In the embodiment shown in FIG. 3, the microlens array chip 302 is integrated into a microscope slide or other holder 306. A jet nozzle 308 injects a fluid, such as a liquid medium 310 that contains samples 312 to be imaged. The liquid stream containing samples 312 can be channelized with the integrated channels that are in or on the microlens array 302 that run from left to right across the page in FIG. 3.

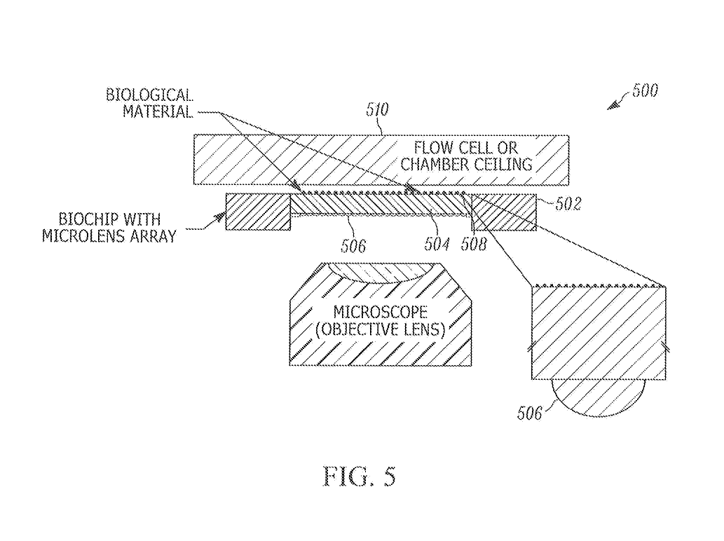

FIG. 4 illustrates an embodiment of an optical imaging system 400 of the present teaching comprising a dual microlens array chip configuration including an upper 402 and a lower microlens array chip 404. The dual microlens array chip imaging system 400 enables imaging of two sides of a biological sample 406. One or more micro-channels 408 are configured between the two microlens array chips 402, 404. In various methods of operation, the biological sample 406 may include whole cells, or cellular sub-components, such as DNA, RNA molecules, nucleus, mitochondria, and other sub-cellular molecules and organelles. In various method of operation, the biological sample 406 itself can be tagged with fluorescent particles, quantum dots, nanotubes, or other types of probes. The imaging system 400 allows an image of the upper and lower structure of the biological sample taken at the same time by positioning one microscope objective 410 on the top adjacent to the upper structure and another microscope objective 412 on the bottom adjacent to the lower structure. Thus, one feature of the imaging system 400 is that it allows two different types of microscopic imaging to be done on the same biological sample simultaneously in time.

Another feature of the present teaching is that micro-fabrication technology can be used to precisely control the parameters of the various structures that are part of the microlens array chips with integrated channels. In various embodiments, the design of the lenslets in the microlens array is such that the imaging resolution of the biological sample is below diffraction limits. The lenslets are design to achieve sub-diffraction-limited resolution by properly selecting the particular index of refraction of the lenslet material, and by properly selecting the particular lenslet shape. In various embodiments, additional focusing mechanisms can be incorporated into the lenslet. For example, the lenslets can include refractive lenses, binary lenses, and/or other focusing techniques.

In some embodiments of the fluidic super resolution optical imaging system according to the present teaching, the design of the lenslets in the microlens array chip support image resolution near or below the diffraction limit while using only low cost optical microscope objectives. In addition, the micro-fabrication methods used to manufacture the microlens array chips according to the present teaching permit integration of lenslets, channels, and other micro-fabricated devices onto one or several substrates to create compact, low-cost imaging systems. Separate microlens arrays of suitable designs can be stacked to become a high- or super-resolution microscope with a very large effective field of view. The stacked 2D arrays can therefore lead to very high throughput.

The micro-fabrication technology used to construct the microlens array chips according to the present teaching allows integration of a microlens array with flow channels of varying dimensions. Depending on the particular application, the flow channels can be micrometer-scale or nanometer-scale dimensions. The shape and size of the channels are chosen to achieve a desired sample presentation to the imaging system.

The sample presentation may be performed on a sample-by-sample basis. For example, the sample presentation may be a single long chain. The samples may be flattened by the channels. The samples may move rapidly or slowly based on the channel size and shape. The microlens array can be put in close proximity and/or contact with the sample that is being imaged. This integration of the microlens array into devices with flow channels permits dense packing for low cost. In addition, this integration provides greater resolution through the refractive index of the lens array and additional focusing mechanisms. Additionally, in some embodiments, optical apertures are patterned on the microlens array chip, minimizing background light and increasing image contrast.

Thus, one feature of the present teaching is that the microlens array chips used for super-resolution imaging can be positioned into close proximity and/or contact with the material being imaged. Thus, the microlens array chips can be manufactured into “biochips” that can be used for a variety of image analysis functions. The term “biochip” as defined herein is a solid substrate that contains a collection of one or more miniature biological test sites.

FIG. 5 illustrates an embodiment of a biological imaging system 500 comprising a biochip 502 with an integrated microlens array chip 504 according to the present teaching. In various embodiments, single or multiple lenslets 506 are arranged in various two-dimensional array patterns on the biochip 502. A biological material sample or probe 508 is either deposited or placed directly on to the biochip 502. Microfluidic channels may also be fabricated on the surface of the biochip. In various embodiments, the sample(s) and/or probe(s) are grown or attached to the biochip by various growth and microfabrication methods. The channels, if present, serve to guide the biologic material or reagent across the microlens array or to change its position on the microlens array. The biological materials, probes or reagent are then moved through the channels using a fluidic material. In other embodiments, the biological materials, probes, or reagent are positioned once on the microlens array and remain stationary during the imaging.

FIG. 5 also illustrates an embodiment with a chamber ceiling 510 that serves to contain the fluid and biologic sample 508 within close proximity to the biochip 502. The individual samples, such as from biological material 508, are positioned within the field of view or focal area of each lenslet. In some embodiments, biological probes are affixed to the microlens array chip 504 that capture and position a targeted biological material presented in a fluid form to the biochip 502.

The biological imaging system 500 illustrated in FIG. 5 can image a wide array of biological materials. In some methods of operation, DNA is sequenced on the biochip with microlens array by starting from a single strand primer with one or more copies per “DNA spot” on the biochip surface, and adding one nucleotide at a time that fluoresces a unique color for each type of nucleotide (A, T, C, G) to sequence each strand, or strands, of DNA on each DNA spot on the biochip 502. Each occurrence of fluorescence is imaged through the microlens array. The same procedure may be used for other strands of nucleic acids, such as RNA or other similar materials.

Microlens array chips can also be used in close proximity to a biochip, or can be integrated into a system that includes both a biochip and a microlens array. The biochips and integrated lens arrays of the present teaching may be integrated into various biological material containment systems to facilitate sample management, including preparation and locomotion through the imaging system. In some embodiments, the biochips are placed in a chamber. In other embodiments, the biochips are placed or integrated into a flow cell with chamber walls above and alongside the biological material for containment. One or more biochips and one or more integrated lens array can be integrated into the imaging system, depending on the required system scale and number of samples and/or analyses being performed.

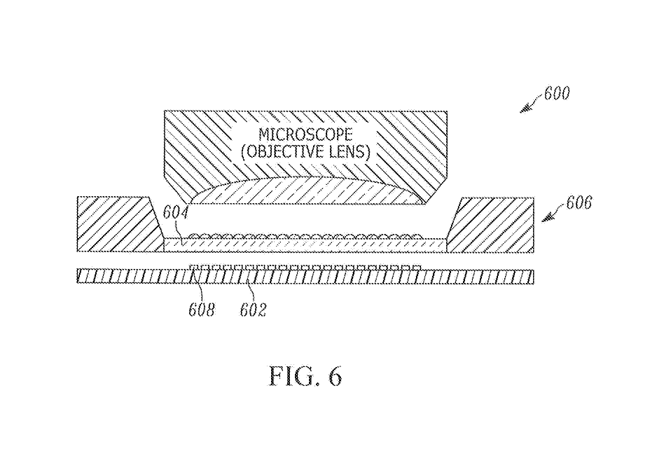

FIG. 6 illustrates an embodiment of a fluidic super resolution optical imaging system 600 comprising a biochip 602 with a microlens array chip 604 integrated into a flow cell 606 and located directly opposite from the biochip 602. The flow cell 606 provides containment for the biological material 608 and fluid used for locomotion. In some embodiments, the flow cell 606 is replaced by a chamber, and the biochip is integrated into a chamber surface, such as wall or ceiling. In some embodiments, the flow cell with integrated microlens array is designed to be a disposable one-time use product. In other embodiments, the flow cell with integrated microlens array is designed to be reusable. The embodiment of the biochip and integrated microlens array shown in FIG. 6 may also be part of a dual microlens array chip configuration, as described in connection with FIG. 4.

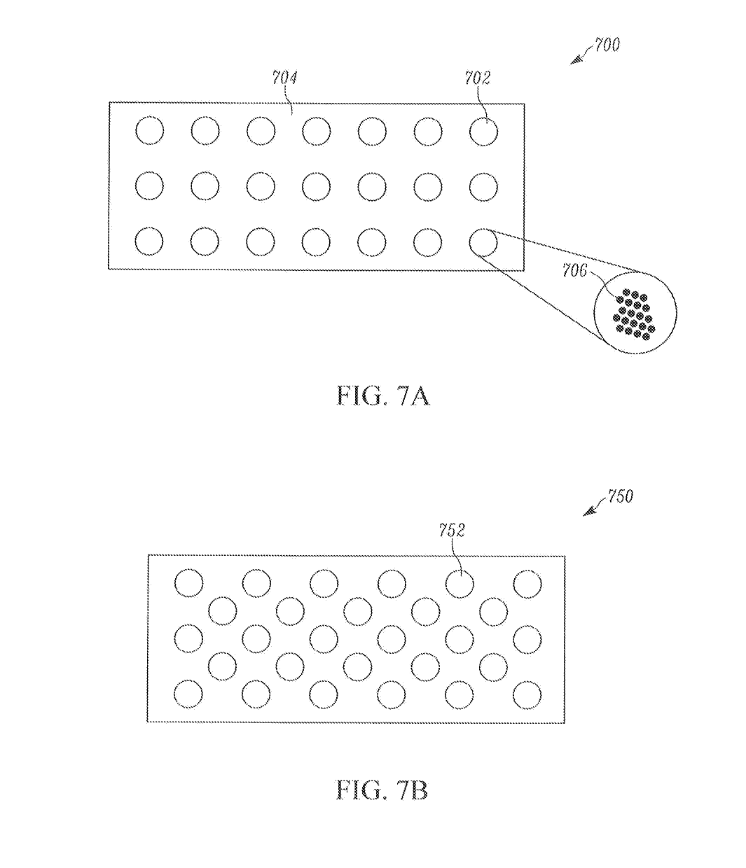

Another feature of the integrated microlens array technology of the current teaching is that numerous lenslet array patterns can be realized. The array may consist of any number of lenslets, including just one lenslet. There may also be one or more arrays on a single microlens array chip. FIG. 7A illustrates an embodiment of a microlens array 700 with a lenslet pattern of the current teaching. The lenslets 702 are in a square-packed array, evenly and regularly spaced on a square grid. FIG. 7A illustrates the position of the lenslet pattern on a section of a biochip 704. In some methods of operation, the biological material 706 is positioned to statically or dynamically pass through the field of view or focal area of a lenslet 702. In some methods of operation, the biological material 706 is proximate to the lenslet or the microlens array surface. In other methods of operation, the biological material is affixed to the back side of the microlens array.

FIG. 7B illustrates an embodiment of a microlens array 750 with a lenslet pattern of the current teaching. The lenslets 752 are shown in a hexagonal close-packed array, with lenslets arranged in two sets of square grids that are offset in both dimensions by half the side length of the square. In various embodiments, the two sets of grids are square, rectangular, hexagonal, or circular. One skilled in the art will appreciate that the grids can be in numerous geometries. Also, in various embodiments, the lenslet pattern is regular or irregular. In some embodiments, the lenslets are bunched in regions to allow separation of various materials and/or analysis methods.

In some embodiments, the biochip and microlens array are used as part of a device to identify the presence of specific sequences of nucleic acids in the form of DNA or RNA. Organic or inorganic probes are affixed to the biochip. These probes can be designed for attracting, attaching, and causing fluorescence on a specific sequence of nucleic acid in the form of DNA or RNA in various targeted sequences and lengths. Each occurrence of fluorescence is imaged through the lenslets in the microlens array.

In some methods of operation, the biochip and microlens array are used as part of an immunoassay device to identify the presence of specific molecules. Organic or inorganic probes may be affixed to the biochip. A fluidic solution can be washed over the biochip with integrated microlens array. The fluid can contain the target molecule to be probed. Probes can be designed for attracting, attaching, and causing fluorescence on a specific molecule, including a wide range of biological and synthetic molecules. Each occurrence of fluorescence is imaged through the microlens array. The biochip can similarly be used as part of a device to identify the presence of cells, bacteria, viruses, sub-cellular organelles, etc.

In some embodiments, the fluidic super resolution optical imaging system of the current teaching is a DNA sequencer, RNA sequencer, or nucleic acid probing system. A DNA sequencer automates the DNA sequencing process. Given a sample of DNA, a DNA sequencer determines the order of the four base nucleotides: adenine, guanine, cytosine, and thymine and reports the order as a text string, called a read. A fluidic super resolution optical DNA sequencer of the current teaching analyzes light signals originating from fluorochromes attached to nucleotides to determine the sequence order.

In some embodiments, the fluidic super resolution optical imaging system of the current teaching is a high content screening/analysis instrument. High-content screening (HCS) and high-content analysis (HCA) identify substances such as small molecules, peptides, or RNAi that alter the phenotype of a cell for biological research and drug discovery applications. Phenotypic changes may include increases or decreases in the production of cellular products, such as proteins, and/or changes in the morphology of the cell. High content screening includes any method used to analyze whole cells or components of cells with simultaneous readout of several parameters. Unlike high-content analysis, high-content screening has a level of throughput. High-content analysis may be high in content but low in throughput. A fluidic super resolution optical HCS and HCA systems of the current teaching analyze light signals originating from small molecules, peptides, or RNAi in a sample passed across the imaging field using fluidic mechanisms.

In some embodiments, the fluidic super resolution optical imaging system of the current teaching is a Polymerase Chain Reaction (PCR) instrument. PCR is used in molecular biology to amplify a single copy or a few copies of a piece of DNA across several orders of magnitude, generating thousands to millions of copies of a particular DNA sequence. A fluidic super resolution optical PCR of the current teaching analyzes light signals originating from pieces of DNA.

In some embodiments, the fluidic super resolution optical imaging system of the current teaching is configured for chromosomal analysis. Chromosome analyzers provide automated mapping of select nucleotides and other characteristics of a long strand of DNA. A fluidic super resolution optical chromosomal analyzer of the current teaching uses light-based imaging in the mapping process to characterize and analyze the number and structure of the chromosomes.

In some embodiments, the fluidic super resolution optical imaging system of the current teaching is immunoassay, protein and molecular probing equipment. An immunoassay is a biochemical test that determines the presence of or measures the concentration of a macromolecule in a solution through the use of an antibody or immunoglobulin. An analyte is a macromolecule detected by the immunoassay and is often a protein. Analytes in biological liquids, such as serum or urine, are frequently measured using immunoassays for medical and research purposes. Immunoassays have various formats. Immunoassays may be run in multiple steps with reagents being added and washed away or separated at different points in the assay.

Multi-step assays are often called separation immunoassays or heterogeneous immunoassays. The use of a calibrator solution that is known to contain a particular concentration of the analyte in question is often employed. Comparison of an assay's response to a real sample against the assay's response produced by the calibrators makes it possible to interpret the signal strength in terms of the presence or concentration of analyte in the sample. A fluidic super resolution optical immunoassay, protein, and molecular probing system of the current teaching uses light-based imaging to probe the analyte.

In some embodiments, the fluidic super resolution optical imaging system of the current teaching is a Fluorescent In Situ Hybridization (FISH) system. FISH is a cytogenetic technique that detects and localizes the presence or absence of specific DNA sequences on chromosomes. A fluidic super resolution FISH system of the current teaching uses fluorescent probes that bind to only those parts of the chromosome with which they show a high degree of sequence complementarily. Fluorescence microscopy is then used to find out where the fluorescent probe is bound to the chromosomes. A fluidic super resolution FISH finds specific features in DNA for use in genetic counseling, medicine, and species identification. A fluidic super resolution FISH also detects and localizes specific RNA targets (mRNA, IncRNA and miRNA) in cells, circulating tumor cells, and tissue samples. In this context, fluidic super resolution FISH helps define the spatial-temporal patterns of gene expression within cells and tissues.

One feature of the fluidic super resolution optical imaging system using biochips and microlens arrays of the present teaching is that the density of the array of biological material, probes, etc., can be denser than prior art imaging systems. Much smaller distances between each item that is to be imaged in the application are possible. In embodiments of the present teaching used for DNA sequencing, a denser array of DNA molecules allows the overall biochip to be smaller for the same number of “DNA spots,” thereby reducing the amount of expensive reagents needed for each step of the process. Because image resolution and contrast are increased, fewer copies of each piece of DNA in each DNA spot are required, which lowers the process time and cost. Imaging process time is decreased, thus speeding the overall process and lowering costs.

Imaging a denser array of nucleic acid probes in DNA, RNA, gene, or other nucleic acid probe-based analyses in a system comprising channelized, integrated microlens arrays of the current teaching allows the overall biochip to be smaller for the same number of probes, thus reducing the amount of expensive reagents needed for each step of the process. Because image resolution and contrast are increased, the biochip has much greater sensitivity to lower numbers of nucleic acid strands that may be present in the solution. Imaging process time is decreased, which accelerates the overall process and lowers costs.

Similarly, imaging denser arrays of protein and other molecules using molecular probes in a system comprising channelized, integrated microlens arrays of the current teaching permits a smaller biochip for the same number of probes, reducing the amounts of expensive reagents needed for each step of the process. Because image resolution and contrast are increased, the biochip has much greater sensitivity to lower numbers of proteins or molecules that may be present in solution. Imaging process time is decreased, lowering costs.

Equivalents

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A fluidic super resolution optical imaging system comprising:
a) a microlens array chip comprising at least one lenslet on a first surface;
b) an objective lens that is positioned proximate to the at least one lenslet; and
c) a fluid jet positioned proximate to a second surface of the microlens array that flows at least one of a fluid comprising a material to be imaged or a material that enables imaging of a second material through a focal area of the objective lens and the at least one lenslet.

2. The fluidic super resolution optical imaging system of claim 1 wherein the at least one lenslet comprises an array of lenslets.

3. The fluidic super resolution optical imaging system of claim 1 wherein the at least one lenslet comprises at least one refractive lens.

4. The fluidic super resolution optical imaging system of claim 1 wherein the at least one lenslet comprises at least one binary lens.

5. The fluidic super resolution optical imaging system of claim 1 wherein the at least one lenslet comprises at least one optical aperture that reduces background light and increases image contrast.

6. The fluidic super resolution optical imaging system of claim 1 wherein the second surface comprises at least one microchannel that has dimensions that are chosen to flatten the material to be imaged.

7. The fluidic super resolution optical imaging system of claim 6 wherein the at least one microchannel has dimensions that are chosen to isolate the material to be imaged.

8. The fluidic super resolution optical imaging system of claim 6 wherein the at least one microchannel comprises a plurality of microchannels.

9. The fluidic super resolution optical imaging system of claim 6 wherein the at least one microchannel is formed on the second surface.

10. The fluidic super resolution optical imaging system of claim 9 wherein the at least one microchannel is etched in the second surface.

11. The fluidic super resolution optical imaging system of claim 9 wherein the at least one microchannel is machined in the second surface.

12. The fluidic super resolution optical imaging system of claim 1 wherein the objective lens comprises a microscope objective lens.

13. The fluidic super resolution optical imaging system of claim 1 wherein the fluid jet flows particles of the material to be imaged through the focal area one-by-one.

14. The fluidic super resolution optical imaging system of claim 1 wherein the fluid jet propels the material to be imaged across the array of lenslets.

15. The fluidic super resolution optical imaging system of claim 1 further comprising a light source that illuminates the focal area.

16. The fluidic super resolution optical imaging system of claim 1 further comprising a second microlens array chip positioned adjacent to the microlens array chip, the second microlens array chip comprising an array of lenslets on a first surface and at least one microchannel positioned proximate to a second surface.

17. The fluidic super resolution optical imaging system of claim 16 further comprising a second objective lens that is positioned proximate to the array of lenslets in the second microlens array chip.

18. The fluidic super resolution optical imaging system of claim 1 wherein the material to be imaged is tagged with at least one of fluorescent particles, quantum dots, and nanotubes.

19. The fluidic super resolution optical imaging system of claim 1 wherein the material to be imaged comprises at least one of biological cells, cellular subcomponents, DNA, RNA molecules, nucleus, mitochondria, sub-cellular molecules, and organelles.

20. The fluidic super resolution optical imaging system of claim 1 wherein the fluidic super resolution optical imaging system is selected from the group consisting of a DNA sequencer, a RNA sequencer, a nucleic acid probing system, high-content screening system, a high-content analysis system, chromosomal analyzing system, a polymerase chain reaction imaging system, an immunoassay, protein and molecular probe system, a fluorescent in situ hybridization system, and a flow cytometer.

21. A nucleic acid imaging system comprising:
a) a microlens array chip comprising at least one lenslet on a first surface;
b) an objective lens that is positioned proximate to the at least one lenslet;
c) a fluid jet positioned proximate to a second surface of the microlens array chip that flows a fluid comprising a biologic sample to be imaged through a focal area of the objective lens and the at least one lenslet; and
d) an analyzer that captures a plurality of images of the biologic sample flowing through the focal area of the objective lens and the at least one lenslet and produces an analysis of the biologic sample from the captured images.

22. The nucleic acid imaging system of claim 21 wherein the at least one lenslet comprises an array of lenslets.

23. The nucleic acid imaging system of claim 21 of claim 1 wherein the at least one lenslet comprises at least one refractive lens.

24. The nucleic acid imaging system of claim 21 wherein the at least one lenslet comprises at least one binary lens.

25. The nucleic acid imaging system of claim 21 wherein the at least one lenslet comprises at least one optical aperture that reduces background light and increases image contrast.

26. The nucleic acid imaging system of claim 21 wherein the objective lens comprises a microscope objective lens.

27. A method of analyzing a biological sample, the method comprising:
a) providing a microlens array chip comprising at least one lenslet on a first surface;
b) positioning an objective lens proximate to the at least one lenslet;
c) flowing a fluid comprising a biological material to be imaged through a focal area of the objective lens and through the at least one lenslet of the microlens array chip;
d) capturing a plurality of images of the biologic sample flowing through the focal area of the objective lens and the at least one lenslet; and
e) characterizing the biologic sample from the captured images.

28. The method of claim 27 further comprising flowing the fluid comprising a material to be imaged proximate to a second surface of the microlens array.

29. The method of claim 27 wherein the biologic sample comprises DNA.

30. The method of claim 29 wherein the characterizing comprises determining a number and a structure of at least one chromosome.

31. The method of claim 27 wherein the biologic sample comprises one of small molecules peptides or RNAi.

32. The method of claim 27 wherein the biologic sample comprises a biologic fluid containing an analyte and the analysis comprises the presence or concentration of the analyte.

33. The method of claim 27 wherein the biologic sample comprises a fluorescent probe and the analysis comprises spatial and/or temporal patterns of a binding of the fluorescent probe to a chromosome.
